(19) United States
(12) Patent Application Publication
(10) Pub. No.: US 2004/0238290 A1
(43) Pub. Date: Dec. 2, 2004

(54) Aircraft ground support equipment (GSE) - airline baggage/mail cart self-adjusting braking system for use in airline gate ramp operations

(76) Inventor: Neva Jane Brown, Lufkin, TX (US)

Correspondence Address: PRECISE INDUSTRIES - ATG, 2015 SPENCE ST., P.O. BOX 150351, TX, 75901, US

(21) Appl. No.: 10/444,645

(22) Filed: May 27, 2003

(51) Int. Cl. B62B 5/04

(52) U.S. Cl. 188/19

(57) ABSTRACT

This invention is directed to a new automatic braking system for large airline baggage/mail carts and incorporates the use of a self-adjusting mechanism to provide positive ‘stop’ and non-rolling movement while the cart is intended to be in a static stationary condition for use by airline ground crew members and does not require any additional cart operator movement or action or directed effort to activate or deactivate the braking system.

The new technical feature of the cart braking system is the design, fabrication and installation of the airline cart bottom frame undercarriage-mounted assembly which incorporates the use of a torqued spring device which allows automatic positioning of the braking cross member to make solid tire contact which provides full stopping and locking of cart movement regardless of tire wear or surface gradient.

The brake assembly includes a threaded brake actuator, notched brake cross members, bolts within tubes, flanged angles, brake cross member guides, steel spring and spring guard assembled and installed on the undercarriage of the cart and automatically activated and deactivated by the upward and downward motion of the cart handle by the operators during normal operations of baggage and mail handling.

### BACKGROUND OF THE INVENTION

Recent independent airline ground operations research studies discovered a definite need for a type of an airline baggage/mail ground cart mechanism whereby when the cart is in a resting (static) position the braking system automatically adjusts to any deteriorating cart tire conditions to provide a safe and sure ‘full stop’ secure condition by positively holding firm the brake bar against the cart tire to prevent any cart movement without requiring any additional cart operator action.

Current ‘on the market’ braking systems for similar carts remain in a ‘fixed position’ structurally when applying the braking mechanism to the cart tire to slow and stop any moving inertia and require an operator to depress a foot or hand brake pedal or lever to engage stopping action either against the cart tire or the floor surface. As the cart's front tires become worn through frequent and abrupt braking applications by the airline baggage crew, the tire's radius gradually reduces thus creating an air ‘space gap’ between the tire's rolling surface and the ‘fixed’ position of current braking systems. As the air gap increases, less stopping surface contact exists and the baggage/mail cart may begin to roll in any direction based on the existing surface gradient.

After consultation with a major airline's ground support equipment maintenance managers, a prototype cart with the self-adusting braking system was designed, fabricated and transported to a major airport for a three (3)-month field trial. During the field trial the cart prototype was utilized in actual airport gate ramp operations twenty-four (24) hours seven (7) days a week.

At six (6) week internals during the field trial, the prototype cart was located, inspected and rated by various ground crew for safety, productivity and reliability. The test cart was rated quite favorably for ‘sure-stop’ ability thus minimizing the possibility for expensive aircraft damage, airport operations vehicle damage, pull-tug damage and potential employee accidents and did not require any cart operator action.

With the observations and feedback from the airline gate ramp operations crew during the field trial, minor design adjustments were effected and incorporated into the ‘final design’ to enhance safe start/stop cart operations during airline passenger baggage loading and unloading without requiring any additional and directed operator actions. The cart handle (tongue) movement up or down during the loading, unloading or towing process automatically activates or deactivates the self-adjusting braking system without the baggage handler or the towtug operator changing any movement in their current activities between aircraft flight gates or while traveling across the airport tarmac.

Previous art in the cited referenced U.S. Pat. Nos. address the use of an energy absorbing/dissipation device to provide secure cart position but the designs require a direct and intentional effort by the operator to put the braking mechanism into effect by a downward push of the foot on a foot pedal against the cart tire or a downward push on a foot lever to secure a floor surface or a downward push on a foot brake pin against the tire or a hand actuated lever to engage or release a cam to cause a lever to push against the cart tire.

The present invention remedies the current deteriorating airline baggage/mail cart braking systems by incorporating an automatic self-adjusting braking system mechanism and eliminates the necessity and the requirement for the cart operator to perform any additional hand, foot or body movements to activate or deactivate any type of a braking mechanism. The present invention provides a cost effective method to incorporate a safe reliable cart braking system either at the point of original equipment manufacture (oem) or as an add-on kit by airline maintenance operations personnel. This invention offers the potential of significant cost savings to the airline industry by affecting a reduction in aircraft damage, passenger baggage damage claims, airport operations vehicle damage and employee lost time incidents.

### BRIEF SUMMARY OF THE INVENTION

The airline baggage/mail cart consisting of a large frame with ends, a roof, two axles with two wheels each and a large handle (tongue) is improved by an automatic self-adjusting braking system which consists of a structural ‘cart-underside’ mounted steel frame containing a self-adjusting mechanism such as a mechanical spring, a pneumatic shock absorber or a hydraulic piston that automatically adjusts to the decreasing cart tire radius to provide full contact for braking purposes and requires no new cart operator effort or movement to engage or disengage the brake adjustments.

When the cart handle is lowered from its upright perpendicular position in a downward arc motion the brake actuator rod which is attached to the handle is pushed backwards towards the rear of the cart thus releasing the tension of the mechanical spring which then relaxes the brake bar position away from the cart tires to allow forward or reverse cart movement.

When the cart handle is raised in an upward arc motion from its horizontal position the brake actuator rod is pulled forward towards the front of the cart thus applying tension and compression to the mechanical spring which automatically pushes the brake bar against the cart tire surface.

The ‘system’ accomodates the cart's gradual tire wear while providing a continuous sure surface grip for the braking bar to make contact to allow quick transition from the slightly-moving rolling (dynamic) state to a resting (static) state with ease.

The ‘system’ is engaged (actuated) by the raising of the cart's front handle (tongue) and disengaged (de-actuated) by the lowering of the cart's front handle. The cart handle is lowered and raised by various airline ground crew members during normal baggage and mail activities and is also used to ‘interconnect’ multiple carts for ‘pulling trains’ on the airport tarmac between various gates.

### BRIEF DESCRIPTION OF THE THE DRAWINGS

The invention drawings depict the various views and material specifications of the airline cart self-adjusting braking system.

The drawings are:

FIG. 1—Cart With Installed Self-Adjusting Braking System

FIG. 1 depicts the side view View A-A of the cart showing the relative position of the self-adjusting braking system fabricated and assembled on the frame chassis underside and linked to the cart tongue.

FIG. 2—Brake Assembly

FIG. 2 depicts the top view View B-B of the the welded assembly of the cart self-adjusting system with the major components (spring, cross member guide, cross member and actuator).

FIG. 3—Brake Cross Member Guide Assembly

FIG. 3 depicts the side view View C-C of the fabricated and assembled brake cross member guide assembly.

FIG. 4—Brake Cross Member

FIG. 4 depicts the side view View D-D of the brake cross member detail.

FIG. 5—Brake Actuator

FIG. 5 depicts the top view View E-E of the brake actuator detail.

### DETAILED DESCRIPTION OF THE INVENTION

The invention is the utilization of an energy loading/dissipation device incorporated into an airline or industrial baggage/mail cart's braking system as a means of providing ‘positive’ braking action as the cart's tires wear over time without requiring any additional cart operator effort or motion to activate or deactivate the braking system. The energy loading/dissipation device may be a mechanical spring, pneumatic shock absorber or hydraulic piston. The use of a mechanical spring is the selected device for the detailed specification description and the invention drawings for this patent application.

Loading (torquing) the spring during the final installation step provides the energy buildup required to apply even, equal and firm stopping pressure to the tires regardless of reduction in tire circumference when the cart tongue is raised (actuated) by airline/industrial ground crew members.

Current cart braking systems provide no brake bar adjustment relative to tire contact and can only apply pressure from a fixed actuated position. As the tire surface wears, less surface contact gradually decreases the effectiveness of the braking system.

The following manufacturing operations and installation sequence of the invention are described in concise terms beginning with the detail part level-to-the subassembly level-to-the final assembly/installation level. Component item nos. and Figure Drawings by Figure Nos. are referenced.

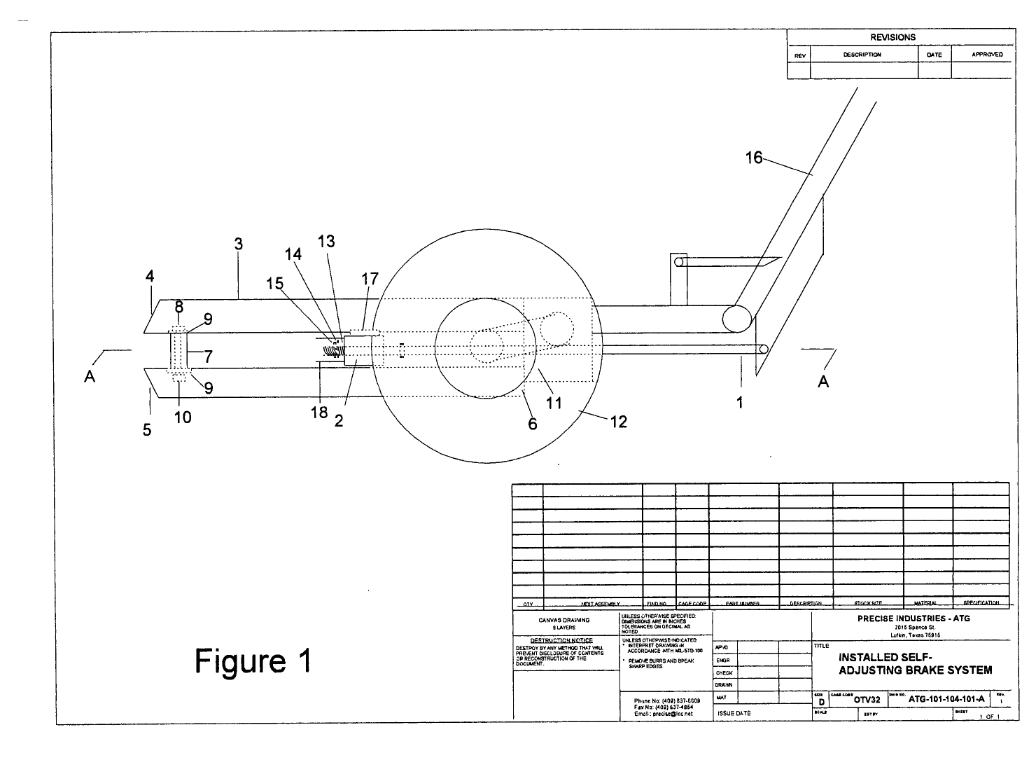

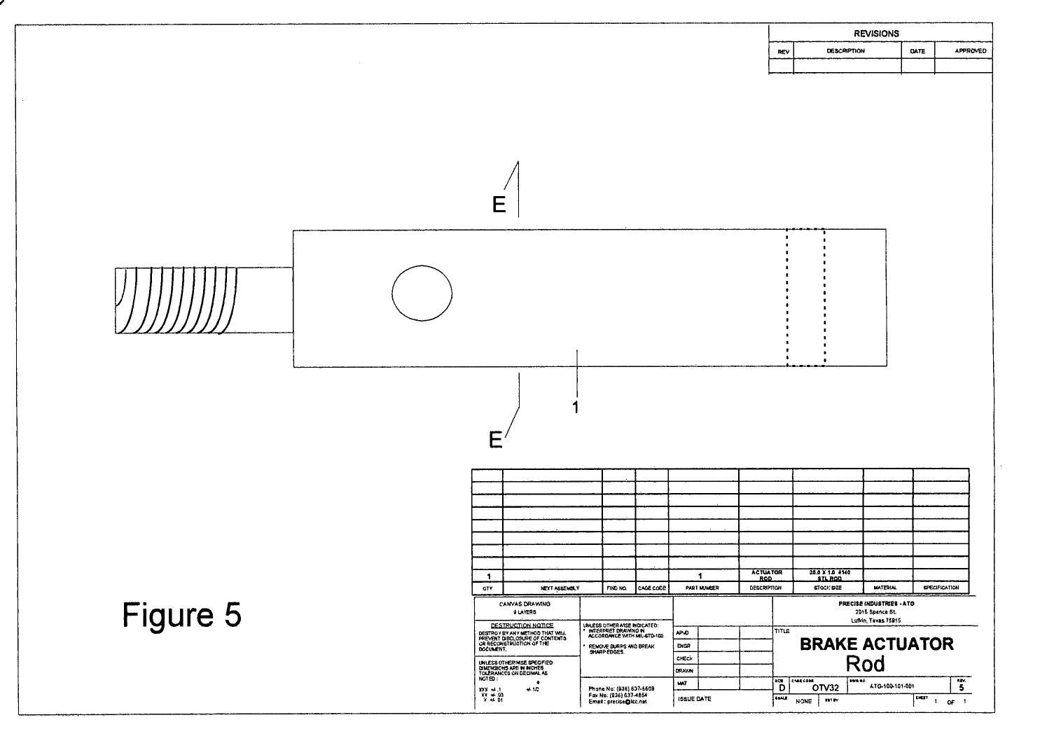

The brake actuator (1) is a new detail part for the cart self-adjusting braking system. A 1.00 inch diameter 4140 steel bar is saw cut to 35.00 inches length and placed in a lathe to face-off one end. The cut rod is then rotated 180 degrees to face-off the opposite end by lathe to 34.00 inches length and turned-down to 0.75 (¾) inch diameter for 3.00 inches length towards the rod center. The 0.75 inch diameter portion is threaded ¾-16 UNF-2A for 2.00 inches back and chamfered at 45 degrees×0.06 inches. A mill is used to drill a 0.375 (⅜) inch diameter hole 6.00 inches from the threaded rod end. The part is turned 180 degrees to drill a 0.375 (⅜) inch diameter hole 0.6875 (11/16) inches distance inward from the threaded end. The two (2) thru-holes, at 6.00 inches and at 0.6875 inches , serve as the de-actuator and tongue linkage respectively. All edges are deburred and smoothed. Refer to Drawing FIG. 1—Installed Self-Adjusting Brake System and Drawing FIG. 5—Brake Actuator.

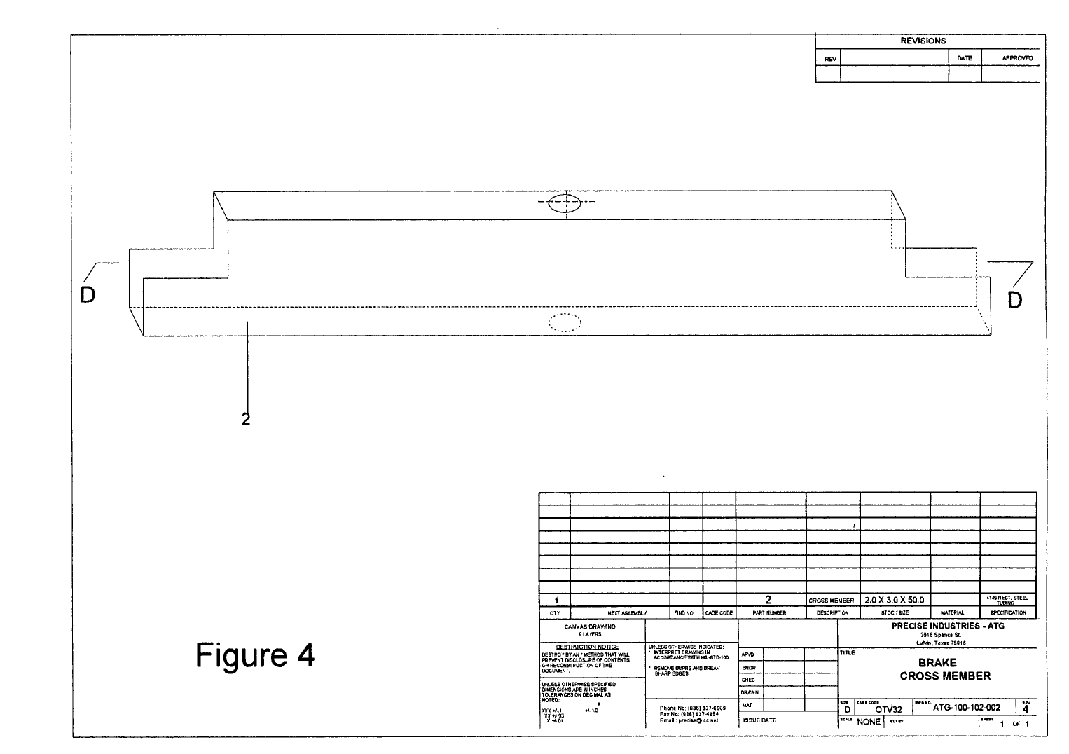

The brake cross member (2) is a new detail part for the cart self-adjusting braking system. Using 4140 steel rectangular tubing (2.00″×3.00″), saw cut to 50.00 inches length. Measure and layout a 0.75 (¾) inch by 4.50 inch dimension for notched inset on both ends and torch cut. Drill a 1.05 inch diameter hole on both sides of the tubing 20.50 inches from the end (on the notched-length centerline). All edges are deburred and smoothed. Refer to Drawing FIG. 1—Installed Self-Adjusting Brake System and Drawing FIG. 4—Brake Cross Member.

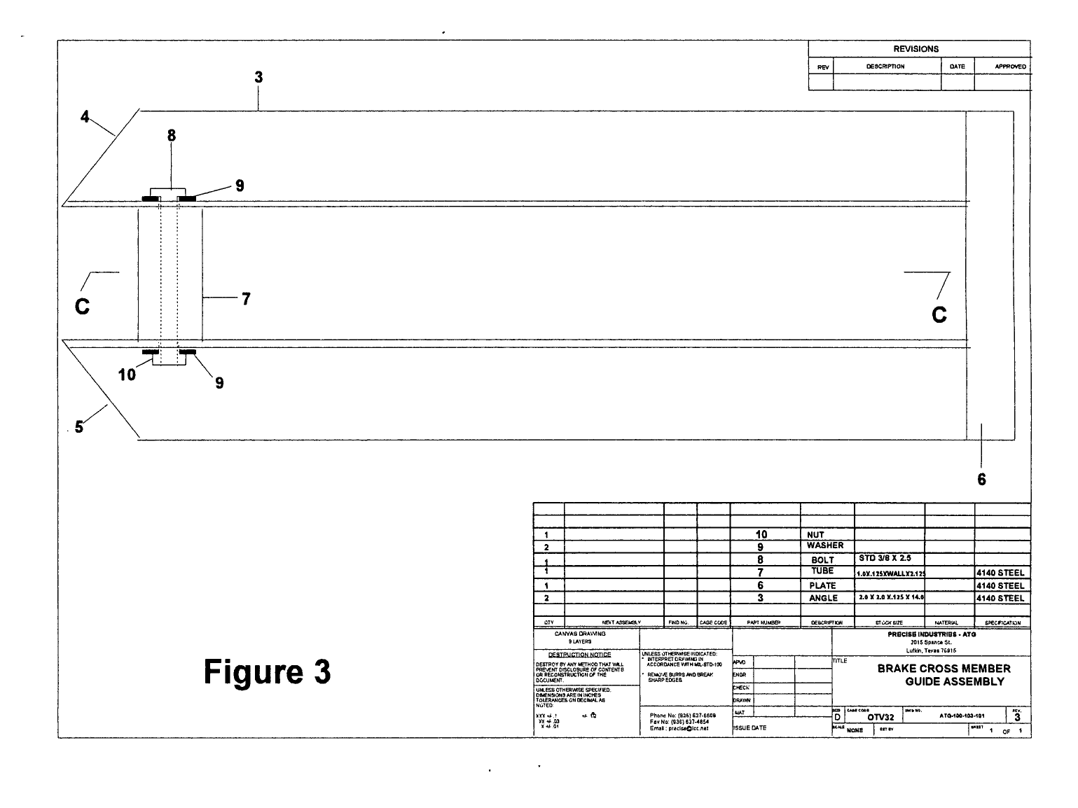

The brake cross member guide assembly (3) is a new subassembly for the cart self-adjusting barking system and requires two (2) each. Saw cut four (4) pieces of 2″×2″×0.125 (⅛) inch 4140 steel angle to fourteen (14) inches length with a 45 degree cut at one (1) end. The 45 degree cuts are opposite in slope from each other with one angle cut ‘flange up’ (4) and the other angle cut ‘flange down’ (5). Saw cut two (2) pieces of 4140 steel plate 0.375″ (⅜) thick×2.00 inches width to 6.125″ length (6). Drill a 0.380″ diameter hole in the center of each angle flange 1.370″ from the 45 degree-cut end of the angle. Saw cut two (2) pieces of 1.0″ diameter×0.125″ thickness 4140 steel tubing to 2.125 inches length (7) and place between the two angles to install two (2) bolts (8), four (4) flat washers (1-top,1-bottom) (9) and two (2) lock nuts (10). Place angle assembly on the steel plate to verify that the inside spacing dimension is 2.125 inches between the two steel angles and MIG (Metal Inert Gas) or GMAW (Gas Metal Arc Welding) weld top and bottom. All edges are deburred and smoothed. Refer to Drawing FIG. 1—Installed Self-Adjusting Brake Assembly and Drawing FIG. 3—Brake Cross Member Guide Assembly.

The final assembly and installation is the final process step of the invention prior to use. Remove the current cart braking system using a cutting torch and clean backside of the front cart axle (11) with a hand grinder and wire brush to remove all coatings and contaminants. Locate, position and install the two (2) guide assemblies (3) with clamp holding fixtures. Slide brake cross member (2) into the guide assemblies to the the tire surfaces and adjust the cross member guides in the vertical center of the tires (12). Install the brake actuator (1) through the center of the cross members and install mechanical spring (13), flat washer (14) and lock nut (15). Attach brake actuator to the cart tongue (16) and actuate the brake by hand application. ‘Load’ the spring (13) all the way down (as tight as possible) by torquing with a hand wrench. Fabricate and install two (2) ½″×½″×2.50″ 4140 steel square keystocks (17) 0.125″ (⅛) inches from the edge of the guide assembly and ‘tack’ weld in place. Verify that the brake assembly slides easily and without friction in both directions (forward/reverse) and MIG weld brake guide assemblies (3) in place. MIG weld keystocks solid on three (3) sides and MIG weld spring guard (18) using 2″×2¼″×4″ 4140 steel tubing. The spring guard (18) provides protection of the spring (13) (or pneumatic shock absorber or hydraulic piston) from inclement weather elements and damaging exterior forces.

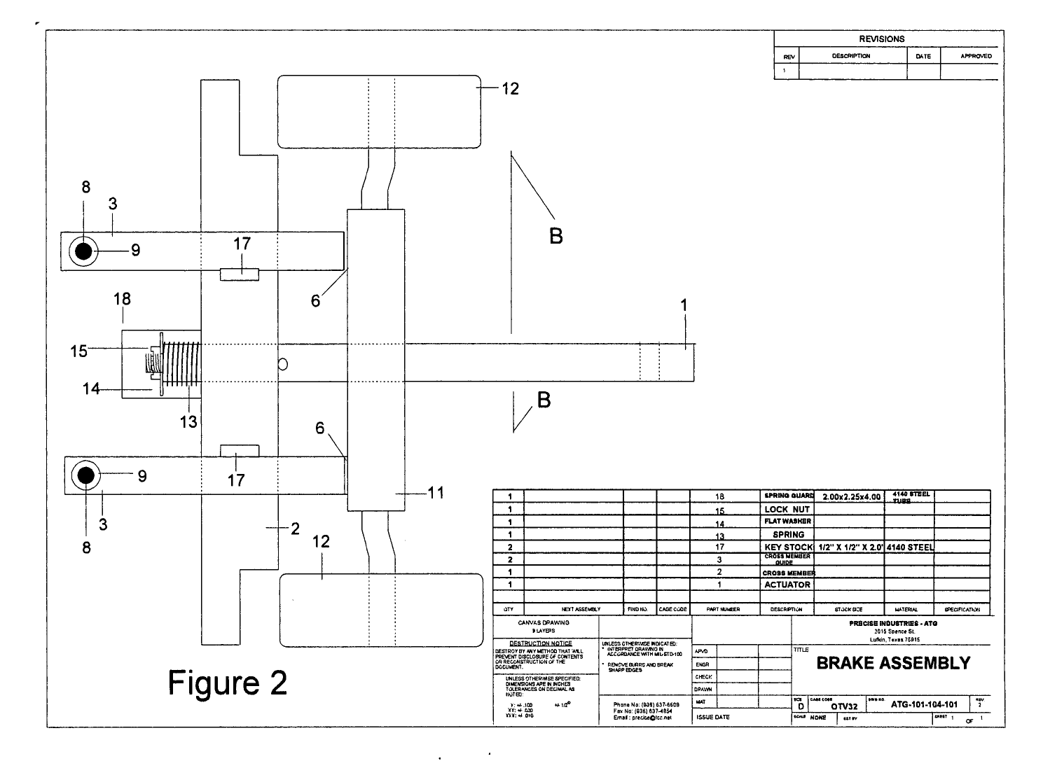

Clean all fabricated steel parts and spray coat with a light gray color primer. Allow to dry thoroughly and spray coat all fabricated parts with an exterior acrylic enamel paint using the customer-chosen color. Allow to dry thoroughly. Only the mechanical spring (or pneumatic shock absorber or hydraulic piston cylinder) is not primed and painted. Refer to Drawing FIG. 1—Installed Self-Adjusting Brake System, Drawing FIG. 2—Brake Assembly and Drawing FIG. 3—Brake Cross Member Guide Assembly.

While the invention has been described with specific references to the drawings and particular embodiments, it is recognized and understood that various and obvious modifications can be made without departing from the scope of coverage of the following claims:

What is claimed is:

1. The improvement to airline baggage/mail carts being a mechanical undercarriage system attached to the cart handle which automatically activates and deactivates a spring-loaded brake mechanism providing full-stop capability and immobile cart position during the passenger baggage loading and unloading process and provides immediate and full-release ability for cart movement to other areas of the airport and to prevent unwanted movement due to the force of wind or the steepness of the tarmac grade and requires no additional or specific cart operator effort or motion, said assembly comprising;
a. a brake actuator cylindrical rod of specified diameter having one end with a flat surface and the other end threaded with a chamfer and having thru-holes to serve as the deactuator and cart tongue linkage point and mounted between the center of the brake cross member guides perpendicular to the brake cross member and;
b. a rectangular brake cross member with both ends notched and a drill-thru hole for brake actuator rod pass-thru from the tongue thru the torqued spring to the spring backplate guard and placed horizontally and tangentially to the vertical center of the cart tire surface and parallel to the cart axle;
c. said pair of opposite flanged brake cross member guide angles with drill-thru holes for separator tubes with bolts to provide proper vertical spacing and alignment and horizontal clearance for the spring assembly mechanism and free movement of the brake actuator rod and welded into perpendicular position on the top surface of the brake cross member;
d. a mechanical spring placed over the threaded rear end of the brake actuator rod touching a rectangular spring guard and secured with a washer-locknut combination such that spring movement is lateral with no vertical movement;
e. said square steel keystocks welded in place to maintain true position for the brake cross member guide assembly perpendicular to the brake cross member and allow free movement of the brake actuator rod linked to the cart tongue which is raised and lowered repeatedly during normal operations.

2. The airline baggage/mail cart of claim 1 wherein a pneumatic shock absorber is placed horizontally between the brake actuator tube backplate and the brake cross member and secured in place to prevent vertical movement and parallel align within the brake actuator tube.

3. The airline baggage/mail cart of claim 2 hydraulic piston cyclinder is placed horizontally between the brake actuator tube backplate and the brake cross member and secured in place to prevent vertical movement and parallel align within the brake actuator tube.
